(19) United States
(12) Patent Application Publication
(10) Pub. No.: US 2008/0164733 A1
(43) Pub. Date: Jul. 10, 2008

(54) CLAMP FOR CLIMATE CONTROL DEVICE

(76) Inventor: Steven C. Giffin, Pasadena, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/625,696

(22) Filed: Jan. 22, 2007

Related U.S. Application Data
(60) Provisional application No. 60/883,995, filed on Jan. 8, 2007.

(51) Int. Cl. B60N 2/56

(52) U.S. Cl. 297/217.1

(57) ABSTRACT

A clamp that can be molded into an object comprising a first wall and a second wall spaced from the first wall. The clamp also comprises a third wall located between the first wall and the second wall. The third wall at least partially defines a first space between the first wall and the third wall. The third wall at least partially defines a second space between the second wall and the third wall. The first space is open in at least two directions, and the third wall is deflectable into the second space. The third wall is at least partially connected to the second wall along a first edge of the second wall and the second wall is connected along a second edge of the second wall to the first wall. The clamp also includes a tapered extension extending from the third wall at least partially into the first space.

### CROSS-REFERENCE TO RELATED APPLICATIONS

This application is related to, and claims priority from, U.S. Provisional Patent Application No. 60/883,995, filed Jan. 8, 2007.

### INCORPORATION BY REFERENCE

The entirety of U.S. Provisional Patent Application No. 60/883,995, filed Jan. 8, 2007, is expressly incorporated by reference herein and made a part of the present specification.

### BACKGROUND OF THE INVENTION

1. Field of the Invention

This invention generally relates to climate control. More specifically, this invention generally relates to a method and apparatus for installing a climate control device on a seat assembly.

2. Description of the Related Art

Temperature modified air for environmentally controlled living or working space is typically provided to relatively extensive areas, such as entire buildings, selected offices, or suites of rooms within a building. In the case of vehicles, such as automobiles, the entire vehicle is typically cooled or heated as a unit. There are many situations, however, wherein more selective or restrictive air temperature modifications are desirable. For example, it is often desirable to provide an individualized climate control for an occupant's seat so that substantially instantaneous heating or cooling can be achieved. For example, in an automotive vehicle exposed to summer weather, where the vehicle has been parked in an unshaded area for a long period of time, the vehicle seat can become very hot and uncomfortable for the occupant for some time after entering and using the vehicle, even with normal air conditioning. Furthermore, even with normal air conditioning, on a hot day, the seated occupant's back and other pressure points may remain sweaty while seated. In the winter time, it is highly desirable to have the ability to quickly warm the seat of the occupant to facilitate the occupant's comfort, especially where the normal vehicle heater is unlikely to warm the vehicle's interior as quickly. For reasons such as these, there have long been various types of individualized climate control systems for vehicle seats.

Such climate control systems typically include a distribution system comprising a combination of channels and passages formed in the cushion of this seat. Climate conditioned air is supplied to these channels and passages by a climate controlled device. Climate conditioned air flows through the channels and passages to cool or heat the space adjacent the surface of the vehicle seat.

There are, however, problems that have been experienced with existing climate control systems for seats. For example, some climate control systems are not easily adapted into existing seat construction methods. For example, in the construction of some seats, ready access between the climate controlled device on the rear of the seat and the distribution channel on the front of the seat is not easily obtainable. As a result, the connection between the climate control device and a vehicle seat may involve a long or tortuous route consisting of many expensive or intricate components.

### SUMMARY OF THE INVENTION

One aspect of the present invention is a housing for a climate control system comprising a first longitudinal guide for receiving a first longitudinal extending rail and a second longitudinal guide for receiving a second longitudinal extending rail. The housing also comprises a clamp integrally molded into the housing of the climate control apparatus. The clamp comprises a first wall and a second wall defining a space between the first wall and the second wall. The second wall is deflectable so as to alter a dimension of the space. The clamp also comprises a side wall closing at least a portion of one end of the space between the first and second walls. The first, second and side walls combine to form a longitudinal and radial stop for a bent portion of the first longitudinal extending rail received in the space.

Another aspect of the present invention is an assembly for a climate control apparatus that includes a claim that comprises a first wall and a second wall spaced from the first wall. The clamp also comprises a third wall located between the first wall and the second wall. The third wall at least partially defines a first space between the first wall and the third wall. The third wall at least partially defines a second space between the second wall and the third wall. The first space is open in at least two directions, and the third wall is deflectable into the second space. The third wall is at least partially connected to the second wall along a first edge of the second wall and the second wall is connected along a second edge of the second wall to the first wall. The clamp also includes a tapered extension extending from the third wall at least partially into the first space.

Yet another aspect of the present invention comprises a method of securing a climate control device to a first rail and a second rail, the first rail comprising a bend that extends radially away from a longitudinal axis of the rail. In the method, the first rail is positioned within a longitudinal groove of a first clamp and at least a portion of the bend of the rail is positioned against a longitudinal stop of the clamp. The first rail is positioned within a longitudinal groove of second clamp. The second rail is positioned within a longitudinal groove of a third clamp.

Yet another aspect of the present invention is a climate control apparatus being capable of providing heated or cooled air to at least a portion of a vehicle seat comprising at least one rail. The apparatus also includes a panel. The panel houses and supports at least a portion of the climate controlled seat assembly. The apparatus also includes a first clamp that is attached to the panel in a first location and on a first side of the panel. The first clamp is attachable to the rail of the vehicle seat at a first rail location. The first rail location includes at least one bend. The first clamp provides six degrees of constraint to the climate control apparatus. The first clamp includes a first portion that is flexible to allow manual installation of the climate control apparatus.

Another aspect of the present invention is climate control apparatus for providing air to at least a portion of a vehicle seat comprising a first rail and a second rail, the first rail comprising a bend that extends radially away from a longitudinal axis of the rail. The apparatus includes a panel and a first connection point comprising a longitudinal groove configured to receive the first rail. A second connection point comprises a second longitudinal groove configured to receive the second rail. A clamp including means for receiving and securing the bend to prevent longitudinal and radial movement of the bend within the clamp.

### BRIEF DESCRIPTION OF THE DRAWINGS

These and other features, aspects, and advantages of the present invention will now be described in connection with preferred embodiments of the invention, in reference the accompanying drawings. The illustrated embodiments, however, are merely examples and are not intended to limit the invention. The drawings include the following ten figures.

FIG. 1A is a perspective view of a vehicle seat assembly with certain features and aspects of the present invention.

FIG. 1B is a rear view of the vehicle seat assembly of FIG. 1A including a climate control apparatus with certain features and aspects of the present invention.

FIG. 1C is a rear view of the vehicle seat assembly of FIG. 1A including the climate control apparatus of FIG. 1B in a modified orientation.

FIG. 2A is a front view of a panel of the climate control apparatus of FIG. 1A wherein the panel is attached to a rail.

FIG. 2B is a side view of a panel of the climate control apparatus of FIG. 1A wherein the panel is attached to a rail.

FIG. 2C is a side view of a panel of the climate control apparatus of FIG. 1A wherein the panel is attached to a rail.

FIG. 3A is a perspective view of the molded clamp of the panel of FIG. 2A.

FIG. 3B is a plan view of the molded clamp of FIG. 3A.

FIG. 3C is an end view of the molded clamp of FIG. 3A.

FIG. 3D is a cross-sectional side view of the molded clamp of FIG. 3A.

FIG. 3E is a cross-sectional side view of the molded clamp of FIG. 3A.

### DETAILED DESCRIPTION OF THE PREFERRED EMBODIMENTS

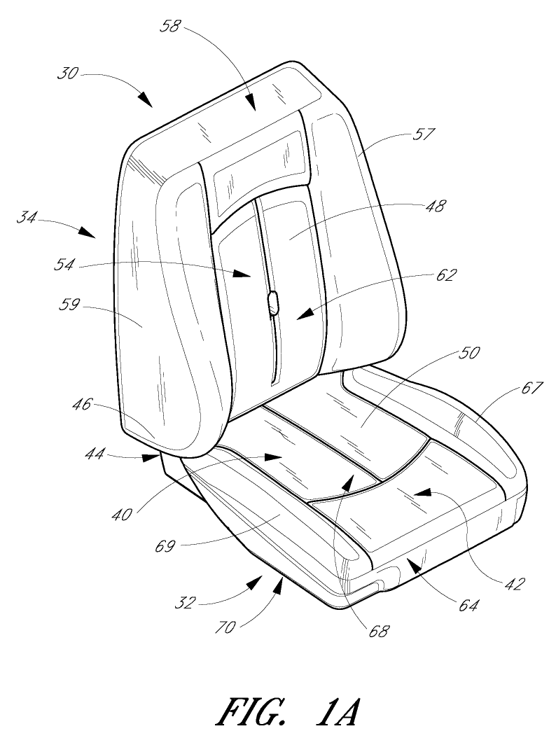

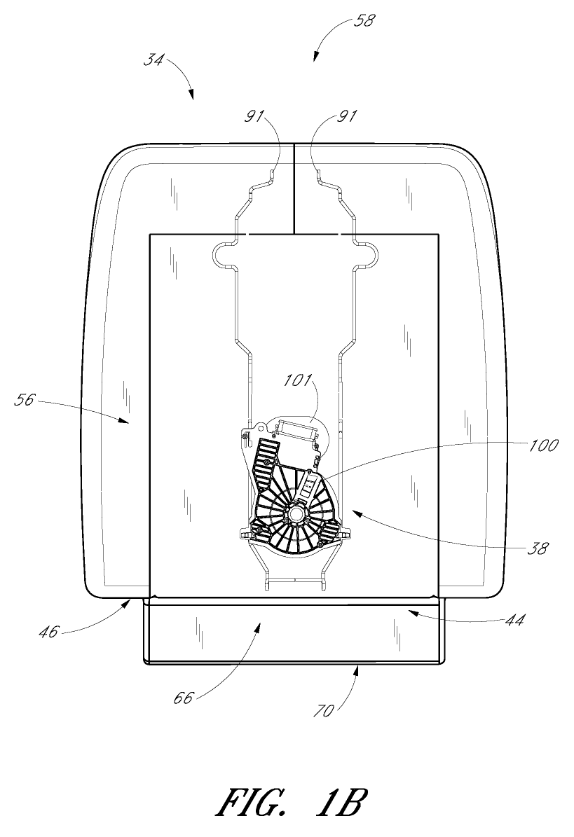

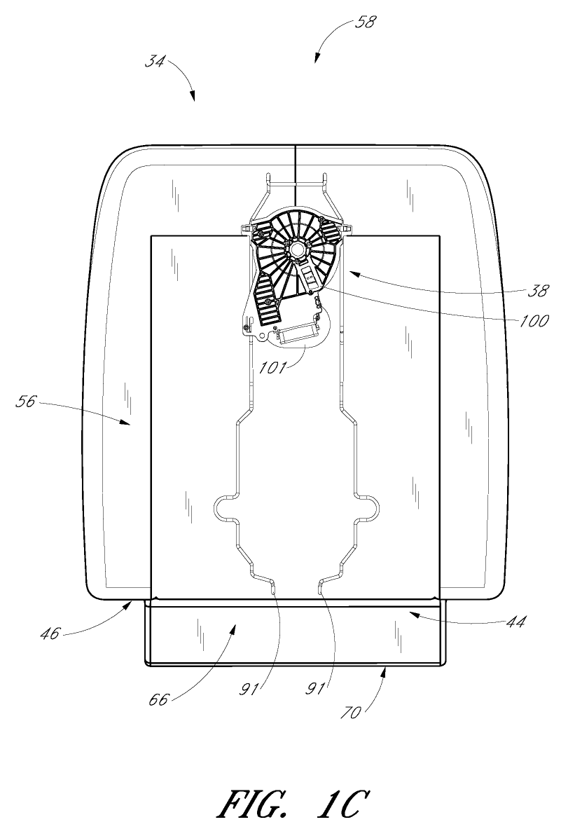

FIGS. 1A and 1B illustrate an exemplary embodiment of a seat assembly 30 with which an embodiment of a clamp may be used. The seat assembly 30 comprises a seat portion 32, a backrest portion 34, and a climate control apparatus 38, which will be described in greater detail below. When an occupant sits in the seat assembly 30, the occupant's seat is located generally in a seat area 40 of the seat portion 32 and at least a portion of their legs are supported by a thigh area 42 of the seat portion 32. In this embodiment, a rear side 44 of the seat portion 32 is coupled to a bottom side 46 of the backrest portion 34. When the occupant sits in the seat assembly 30, the occupant's back contacts the front surface 48 of the backrest portion 34 and the occupant's seat and legs contact a top surface 50 of the seat portion 32. The surfaces 48, 50 cooperate to support the occupant in a sitting position. The seat assembly 30 can be configured and sized to accommodate occupants of various size and weight.

With continued reference to FIGS. 1A and 1B, the backrest 34 has a front side 54, a rear side 56, a top side 58 and a bottom side 46. The backrest 34 includes a pair of sides 57, and 59 extending between the top side 58, and bottom side 46 for providing lateral support to the occupant of the seat assembly 30. A lumbar region 62 of the backrest 34 is generally positioned between the sides 57, 59 of the backrest 34 near the seat portion 32.

In a similar manner, the seat portion 32 has a front side 64, a rear side 44, a top side 68 and a bottom side 70. The seat portion 32 also includes a pair of sides 69 and 67 that extend from the rear side 44 and the front side 64 for providing lateral support to the occupant of the seat assembly 30. In one embodiment, the seat assembly 30 is secured to a vehicle by attaching the bottom side 70 of the seat portion 32 to the floor of a vehicle.

As shown in FIGS. 1A and 1B, the backrest 32 is generally formed by a cushion that is covered with an appropriate covering material (e.g., upholstery). The cushion is typically supported on a metallic frame (not shown). In some embodiments, springs may be positioned between the frame and the cushion. The frame provides the seat assembly 30 with structural support while the cushion provides a soft seating surface. The covering material provides an aesthetic appearance and soft feel to the surface of the seat assembly 30. The seat portion 32 may be constructed in a similar manner as the backrest 34. The cushion 72 can be a typical automotive seat cushion foam or other types of materials with suitable characteristics for providing support to an occupant. Such materials include, but are not limited to, closed or open-celled foam.

In the illustrated embodiment, the seat assembly 30 is similar to a standard automotive seat. However, it should be appreciated that certain features and aspects of the seat assembly 30 described herein may also be used in a variety of other applications and environments. For example, certain features and aspects of the seat assembly 30 may be adapted for use in other vehicles, such as, for example, an airplane, a boat, wheelchairs, or the like. Further, certain features and aspects of the seat assembly 30 may also be adapted for use in stationary environments, such as, for example, a chair, a sofa, a theater seat, and an office seat that is used in a place of business and/or residence. In addition, certain features and aspects of the seat assembly 30 can be adapted for use in devices that do not support a person in a seated position, such as, for example, beds.

In some embodiments, the seat 30 may be configured to distribute air through the seat portion 32 and/or the backrest 30. In such an embodiment, a number of channels may be formed in the seat portion 32 and/or at the backrest 30. See e.g., U.S. Pat. No. 7,114,771, filed May 25, 2004, the entire contents of which are hereby incorporated by reference herein. Such channels are generally configured to distribute air from a bottom or back side of seat portion 32 and/or the backrest 30 through the cushion 72 and along the top surface 50 of the seat portion 32 and/or the front surface 48 of the backrest 30. The channels can be covered with cover members with one or more openings and/or a distribution layer, which are in turn covered with the covering material (e.g., upholstery). In this manner, air from the back or bottom of seat 30 can be removed and/or delivered to the front and top surfaces of the seat.

With reference to FIG. 1B, the rear side 56 of the backrest 34 can be provided with one or more elongated structural members 91. In the illustrated embodiment the structural members 91 comprise wire or tube like rails. In some embodiments, various components of the seat assembly 30 (e.g., an adjustable lumbar support device) can be coupled to the rails 91 for support.

With continued reference to FIG. 1B, a climate control apparatus 38 that is configured to provide fluid flow to the front side 54 of the backrest 34 can be coupled and supported on the rails 91. In one embodiment, the climate control apparatus preferably provides conditioned (e.g., heated and/or cooled) air to the front side 54 of the backrest 34. Accordingly, the climate control apparatus 38 preferably includes a fluid system, which preferably includes a pumping device (e.g., an axial or radial fan) for pumping fluid (e.g., air). In a preferred embodiment, the fluid system also includes a heat transfer device for thermally conditioning (e.g., heating and/or cooling) the pumped fluid. In one embodiment, the fluid system comprises a heat transfer device as described in U.S. Pat. Nos. 6,223,539, 6,119,463, 5,524,439 or 5,626,021, which are hereby incorporated by reference in their entirety. In one preferred embodiment, the fluid system utilizes a Peltier Circuit for cooling and/or heating the fluid. An example of such a system is currently sold under the trademark Micro-Thermal Module™ by Amerigon, Inc. In other embodiments, the climate control apparatus 38 is configured to provide unconditioned air to the seat 30 and/or to remove air from the front and top surfaces of the seat 30.

FIG. 1C illustrates an alternate embodiment of an orientation of the climate control apparatus 38. As apposed to FIG. 1B wherein the climate control apparatus 38 is located generally near the bottom side 46 of the backrest portion 34 with ends of the rails 91 near the top side 58 of the backrest portion 34, in the embodiment illustrated in FIG. 1C the climate control apparatus is located generally near the top side 58 and the ends of the rails 91 are oriented generally near the bottom side 46 of the backrest portion 34. As will be appreciated by one skilled in the art the climate contrail apparatus 38 and the rails 91 can be oriented in various other suitable manners and are not limited to the illustrated embodiments.

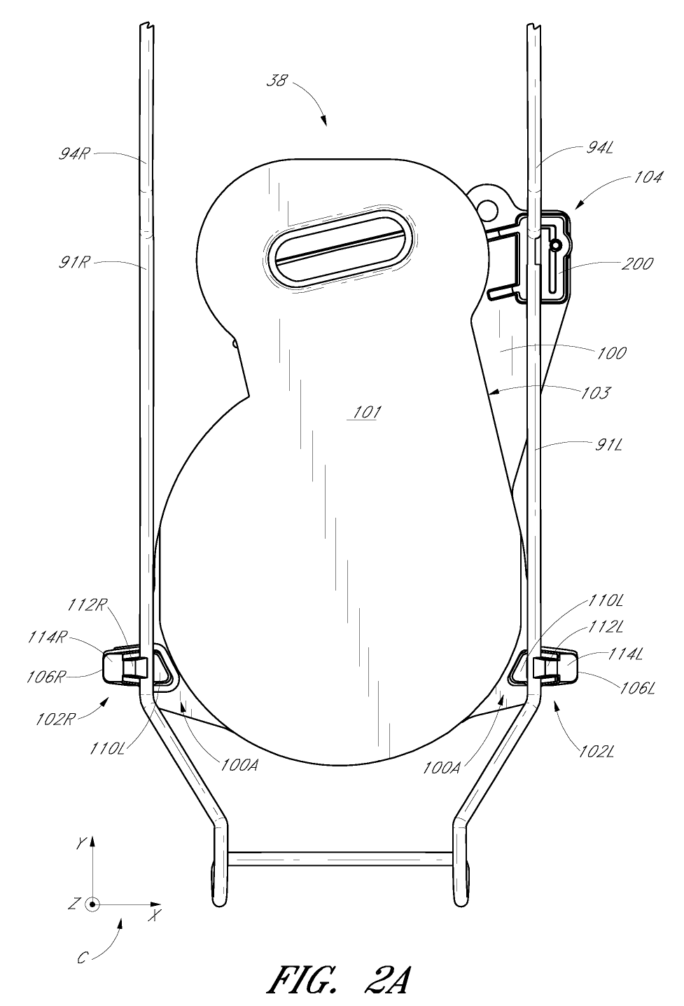

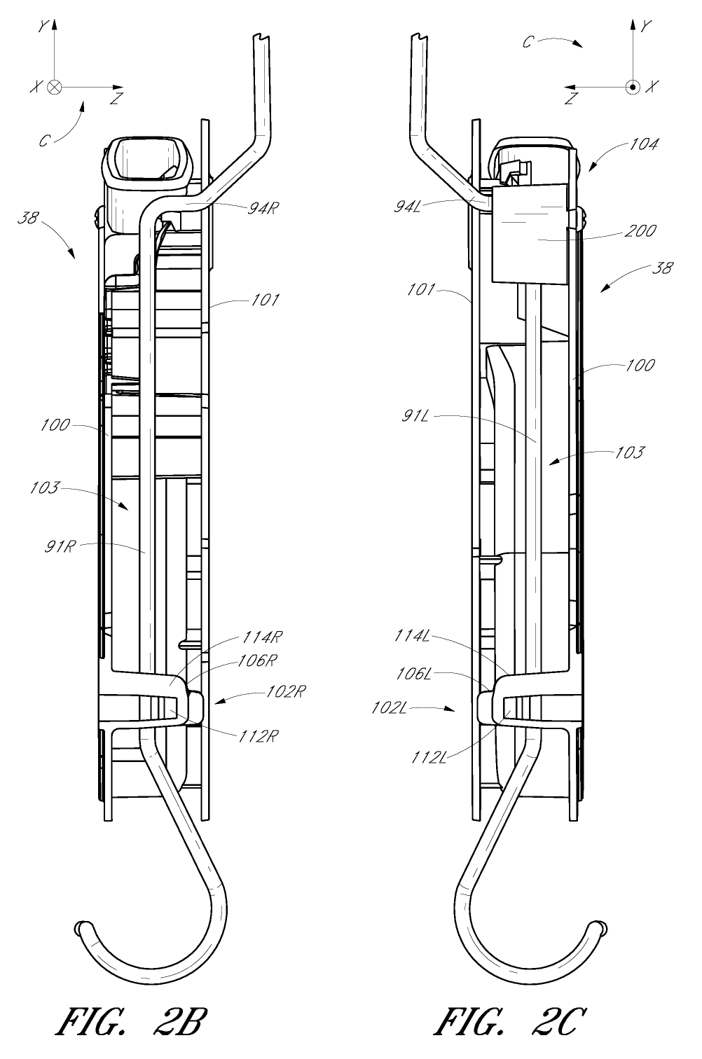

As shown in FIG. 2A, the climate control apparatus 38 preferably positioned at least in part within a housing 99. The housing 99 can be formed from plastic which can be molded. In the illustrated embodiment, the housing 99 includes a rear panel 100 and a front panel 101 that can be generally flat, planar pieces that oppose each other. A side wall 103 can extend between the front and rear panels 100, 101. Together, these components 100, 101, 103 can house and/or support the internal workings of the climate control apparatus 38. As will be explained below, in some embodiments, the panel 100 can also plays a role in coupling the climate control apparatus 38 to the rails 91 to secure the climate control apparatus 38 to the backrest 34 of the seat 30.

Although the climate control apparatus 38 illustrated in FIG. 1A is shown being coupled to rails 91 which are connected to the backrest 34 of the seat 30, in other embodiments, the rails 91 or similar elongated structures may be connected to the seat portion 32. Furthermore, the rails 91 may, in some embodiments, be located in various other positions on or around the seat assembly 30. As will be appreciated by one skilled in the art, the climate control apparatus 38 may be coupled to the rails 91 regardless of their location.

FIGS. 2A-2C illustrate a front view, left view, and right view of the climate control apparatus 38 attached to the rails 91, which further comprise bends 94R, 94L. In some embodiments the panel 100, 101 work together to house and/or support the climate control apparatus 38. The panel 100 preferably is attached to the rails 91 at three connection points. The three connection points, in some embodiments, may comprise two lower connection points 102 and one upper connection point 104. The connection points 102L, 104 preferably are connected to the left rail 91L and the right connection point 102R preferably is connected to the right rail 91R.

Although the illustrated embodiment of the rails 91 include bends 94 which comprise an approximately 90° bend that extends radially away from the longitudinal axis of the rail, preferably in a direction that is neither away or closer to the opposing rail 91. In other embodiments, other angles or directions of the bends or bent transitions may be used and/or the bends can be eliminated. For example, in other embodiments, a suitable bend may include an approximately 30° bend angle or an approximately 45°. As will be appreciated by one skilled in the art, and as will become more apparent below, the 90° bends does provide certain advantages to the configuration.

The connection points 102L, 102R, 104 preferably comprise clamps 106 (also referred to herein as clamps 106L, 106R), 200. In one embodiment, the clamps can be integrally molded or otherwise formed with the panel 100. The clamps 106, 200 preferably are configured to constrain appropriate degrees of freedom of the panel 100 so as to secure the climate control apparatus 38 in the substantially secured position along the rails 91. Such constrained degrees of freedom will be discussed in greater detail below.

With continued reference to FIGS. 2A-2C, the lower clamps 106L, 106R preferably are located on a lower portion 100a of the panel 100 and can be substantially mirror images of one another. The clamps 106L, 106R preferably comprise a backing portion 110, a deflectable prong 112, and a support 114. The prong 112 is preferably flexibly attached to the support 114, however, in other embodiments the prong 112 can be attached by a hinge and may further employ a spring. The backing portion 110 preferably is sufficiently strong to support a straight portion of the rail 91 so the prong 112 may move over a side of the rail 91 to secure the rail 91 within the clamps 106L, 106R. The support 114 can be angled with respect to the backing portion 110 so as to provide a tapered entry for the rail 91 to enter into the clamps 106L, 106R. The backing portion 110 and the support 114 together can define longitudinal channel, which is configured to receive the rails as shown in FIG. 2A.

The lower clamps 106L, 106R can be configured to secure several degrees of freedom of the panel 100. As seen in FIG. 2A-2C, and with reference to the coordinate system C, the longitudinal channel define by the clamps 106L, 106R can constrain the panel 100 in X axis displacement and rotation about the Z axis. With the addition of the prongs 112, Z axis displacement and rotation about the X axis can be limited When combined together, the clamps 106 preferably constrain the panel 100 in five degrees of freedom, including, X axis displacement, Z axis displacement, rotation about the Z axis, rotation about the X axis, and rotation about the Y axis. As will be appreciated by one skilled in the art, the coordinate system C is provided simply for convenience of description, and is in no way intended to limit the scope of the technology.

The upper clamp 200 preferably is configured to secure several degrees of freedom of the panel 100. With reference to the coordinate system C the clamp 200 preferably is configured to constrain the panel 100 in X axis displacement, Z axis displacement, Y axis displacement, rotation about the Z axis, rotation about the X axis, and rotation about the Y axis. As described herein the term constrain is meant to mean, without limitation, that the panel 100 is substantially biased and does not imply complete and immovable clamping although in some embodiments little or no motion is allowed. In various embodiments, the clamps 106L, 106R, 200 can provide various degrees of clamping force, and thus constraint, depending on the method of manufacture and/or materials used to create the clamps 106 and 200.

Although the illustrated embodiment in FIGS. 2A-2C is illustrated with clamps 106L, 106R that constrain the backing plate 100 in five degrees of freedom, a clamp, or clamps, which provide less degrees of constraint, may be used at the lower connection points 102. Such an example of clamps that may comprise less degrees of constraint may include the clamps 106L, 106R to be used without the prongs 112. That is, in some embodiments, the rails 91 may simply rest in the longitudinal channels or grooves defined by the clamps 106L, 106R and may not be secured in place by the snaps 112. In such, an embodiment the clamps 106L, 106R can be used as longitudinal guides for the rails 91.

The clamps 106L, 106R, 200 preferably, in some embodiments are configured so that the clamps 106L, 106R, 200 be easily snapped onto the rails 91 without the use of tools. That is the clamps 106L, 106R, 200 preferably are configured to manually snap or clip on to the rails 91. In some embodiments this can ease installation of the climate control apparatus 38 on the rails 91. Another advantage presented by the illustrated embodiment of clamps 106L, 106R, 200 is that they are generally one solid component and/integrally formed with at least a portion of the housing 91. This is particularly advantageous in that there are minimal components when attaching the climate control apparatus to the rails 91.

Although the clamps 106L, 106R, 200 have been shown as integrally molded clamps being formed with the panel 100, the clamps 106 and 200, in some embodiments, may comprise clamps that are formed separately from, and attached to, the panel 100. Furthermore, the clamps 106L, 106R, 200 may be formed by other methods that may comprise other manufacturing techniques such as machining. Also, in some embodiments, the back panel and the clamps 106L, 106R, 200 are preferably made of a plastic or composite material; however, in other embodiments the panel 100 and or the clamps 106L, 106R, 200 can be made of various other materials including various rubbers or metals or combinations thereof.

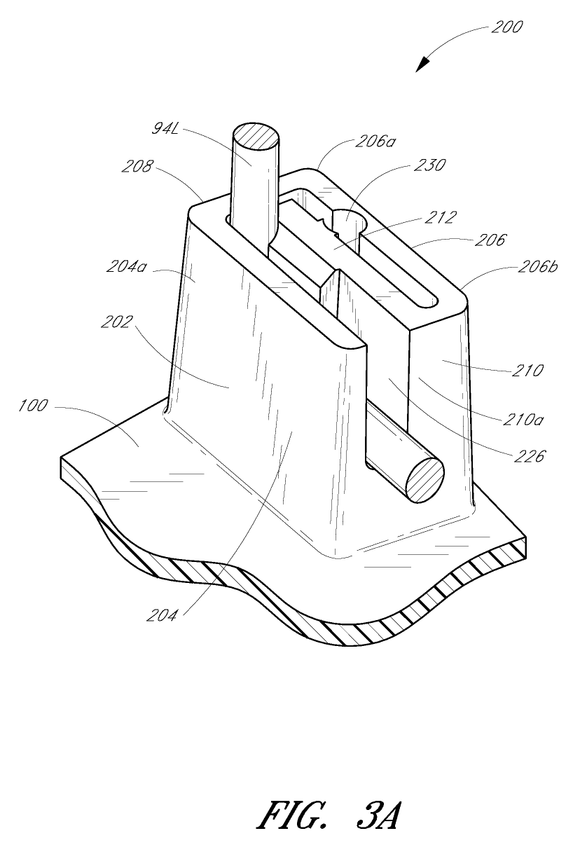

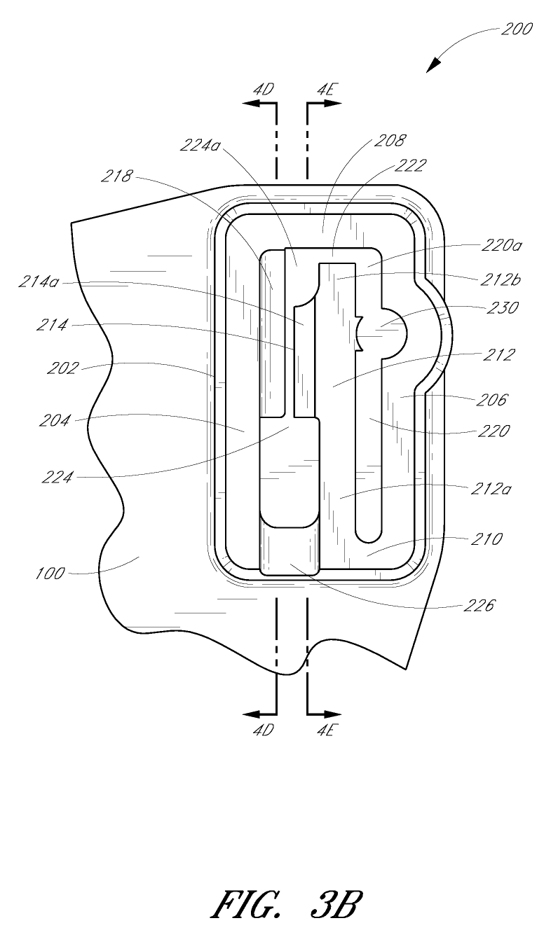

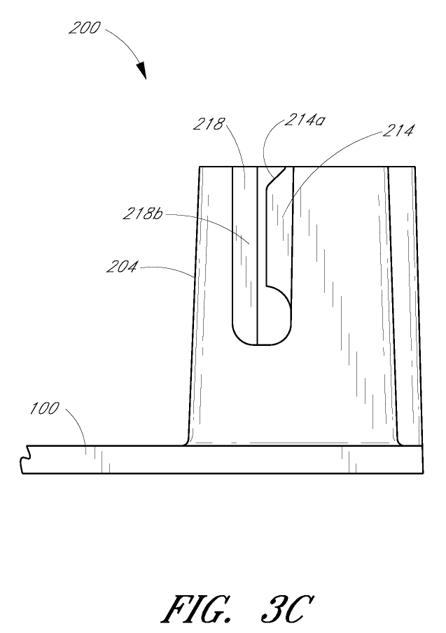

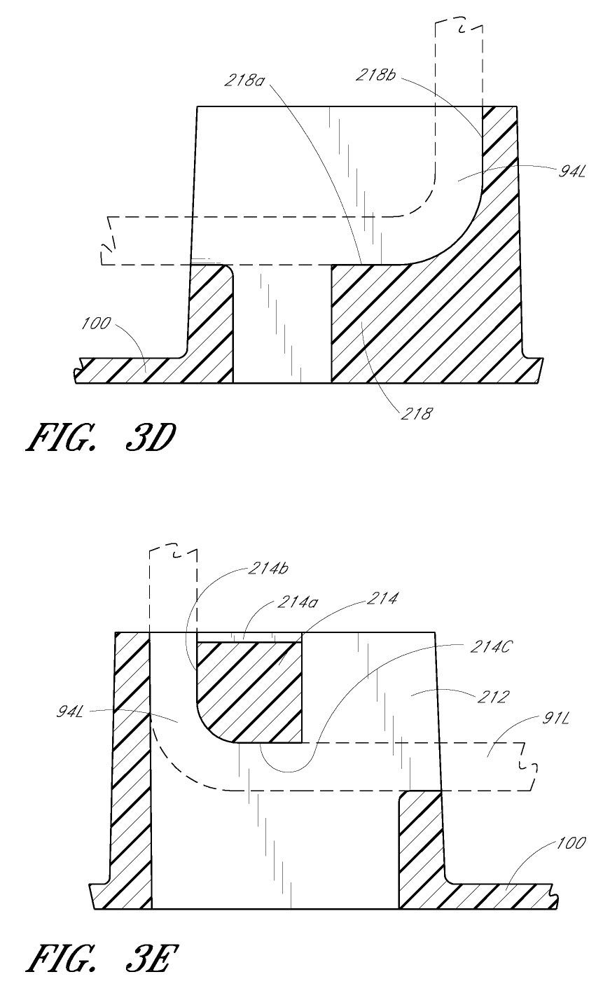

With reference to FIGS. 3A-3E, the upper clamp 200 is illustrated in greater detail. As best seen in FIG. 3A, the upper clamp 200 is shown with the bend 94L of the rails 91 inserted into the clamp 200 such that the bend 94L is substantially constrained in six degrees of freedom. Accordingly, as will be described below, the upper clamp 200 preferably provides a longitudinal stop or the bend 94L and in some embodiments a prong that can be used to further secure the rail within the upper clamp 200.

In the illustrated embodiment, the clamp 200 comprises a generally rectangle outer surface 202 that extends upward from the panel 100. The general structure of the outer surface 202 preferably comprises a first wall 204, a second wall 212 and a third wall 206, and side wall 208. The third wall 206 and the first wall 204 preferably are spaced apart and are connected along their edges 206a, 204a by the side wall 208. The walls 204, 206, 208 generally comprise a three sided rectangular structure. Furthermore, the molded clamp 200 preferably comprises another relatively intermediate wall 210 that is preferably connected to the edge 206b of the third wall 206. The intermediate wall 210 is preferably narrower than the side wall 208 and, in some embodiments, is approximately half of the width of the side wall 208.

Extending from, and connected to, the edge 210a of the intermediate wall 210 is preferably the second wall 212 that extends from the intermediate wall 210 toward the side wall 208, and preferably is generally parallel to the first and third walls 204, 206. Furthermore, the second wall 212 is preferably located generally centrally between the first and third walls 204, 206. The end 212b of the second wall 212 is preferably configured to be displaceable relative to the first wall 204.

As best seen in FIGS. 3B, 3C, and 3E, the second wall 212, in some embodiments, also comprises an extension 214 which preferably extends from the second wall 212 toward the first wall 204 and extends over a portion of the side of the second wall 212 facing the wall 204. The extension 214 is preferably tapered along its upper edge 214a so as to easily allow the rail 91 to enter the clamp 200. Furthermore, the edge 214b and 214c preferably comprise a radius which, in some embodiments, closely matches the shape of the rails 91.

As best seen in FIG. 3B-3D, the first wall 204 preferably also comprises an extension 218 that preferably extends from the first wall 204 toward the third wall 206 so as to provide a supporting structure for the bend 94L. The edges 218a and 218b also preferably comprise a radius which, in some embodiments, is preferably shaped to closely match the shape of the rails 91. The extension 218 also preferably serves as a locating structure to locate the bend 94L when the bend 94L is inserted into the clamp 200. That is, the extension 218 provides a bottoming surface for insertion of the bend 94L into the clamp 200.

As best seen in FIG. 3B, the first and third walls 204, 206, and second wall 212 preferably are arranged such that spaces 220, 222, and 224 are defined between the walls 204, 206, 212. Furthermore, it is preferable that the end 220a of the space 220 is in communication with the space 222 that is in communication the end 224a of the space 224, which is in turn in communication with the surrounding space, through the outer surface 202 of the molded clamp 200. That is, the opening 226 preferably provides communication through the outer surface 202 between the space 224 and the surrounding area. In some embodiments, it is preferable that the spaces 220, 222, and 224 preferably pass through the molded clamp 200 such that the spaces 220, 222, and 224 are generally only bound by the walls 204, 206, 210, 212, and 208. By providing spaces 220, 222, and 224 that pass through the molded clamp 200, the second wall 212 is provided with adequate flexibility to allow the bend 94L to be inserted into the clamp 200.

As best seen in FIG. 3A-3B, when the bend 94L is to be inserted into the clamp 200 the second wall 212 preferably flexes about an end 212a such that at least a portion of the second wall 212 displaces into the space 220. In some embodiments, once the bend 94L has been inserted into the clamp 200 such that the bend 94L is resting firmly against the extension 218, the second wall 212 preferably returns to a substantially parallel position, relative to the first and third walls 204, 206. After the second wall 212 has returned to its original position the elbow 94 is preferably held securely in place in the clamp 200. Accordingly, the clamp 200 provides a longitudinal and lateral stop for the bend 94L. Although the illustrated embodiment shows a second wall 212 which is flexibly attached to the wall 210, in other embodiment the second wall 212 may be attached by a hinge and may further employ a spring to produce a biasing on the second wall 212.

As best seen in FIG. 3B the second wall 212 and the third wall 206 may comprise a recess 230 which is configured to receive a fastener, such as a coarse thread screw. The recess 230 may provide a space in which to insert a fastener which, in some embodiments, may provide additional stability to the second wall 212, which in turn, may provide additional clamping force to the elbow 94L. That is, if a fastener is used, the elbow 94 may be more securely held in the clamp 200 after insertion. As will be appreciated by one skilled in the art, in some embodiments, the clamp 200 may omit the recess 230. Furthermore, as will be appreciated by one skilled in the art, if a fastener is used the fastener can enter the recess 230 from either the top or the bottom of the molded clamp 200.

It should also be appreciated that in modified embodiments the clamp 200 can be configured to interact with a rail that does not include a bend.

Although the above described embodiment of the clamp 200 has been described with reference to a climate control apparatus 38, the clamp can be used in other significantly different applications. For example the clamp can be modified to work in piping or conduit applications. Such an application can comprise a device in which piping or conduit are routed in or on a device and an embodiment of the clamp is used to secure the piping or conduit securely in place.

Throughout the description above, certain relative terms such as upper, lower, front, back, side, top, bottom, etc. have been used to describe various components and assemblies. The terms are meant strictly to assist the reader and are in no way intended to limit the scope of the invention. For example, as described with reference to FIG. 1B, some preferred embodiments may comprise the climate control apparatus 38 to be oriented differently than described above. For example, in one embodiment, the climate control apparatus 38 is inverted (as shown in FIG. 1C) compared to that illustrated in FIG. 1B. Furthermore, certain numerical relative terms such as first, second, and third have also been used to describe certain components and assemblies. Once again this is in no way intended to limit the scope of the invention and is simply used for convenience and ease of description. Furthermore, it should be noted that the relative terms do not necessarily correspond to the relative terms used below in the Claims.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. In addition, while the number of variations of the invention have been shown and described in detail, other modifications, which are within the scope of this invention, will be readily apparent to those of skill in the art based upon this disclosure. It is also contemplated that various combinations or subcombinations of the specific features and aspects of the embodiments may be made and still fall within the scope of the invention. Accordingly, it should be understood that various features and aspects of the disclosed embodiments can be combined with, or substituted for, one another in order to perform varying modes of the disclosed invention. Thus, it is intended that the scope of the present invention herein disclosed should not be limited by the particular disclosed embodiments described above, but should be determined only by a fair reading of the claims.

What is claimed is:

1. A housing for a climate control system, comprising:
a first longitudinal guide for receiving a first longitudinal extending rail;
a second longitudinal guide for receiving a second longitudinal extending rail a clamp integrally molded into the housing of the climate control apparatus, the camp comprising
a first wall; and
a second wall defining a space between the first wall and the second wall, the second wall being deflectable so as to alter a dimension of the space; and
a side wall closing at least a portion of one end of the space between the first and second walls;
wherein the first, second and side walls combine to form a longitudinal and radial stop for a bent portion of the first longitudinal extending rail received in the space.

2. The housing of claim 1, wherein the housing is made of a plastic.

3. The housing of claim 1, wherein the clamp further comprises a recess disposed between the second wall and a third wall, the recess configured to receive a fastener.

4. The housing of claim 1, wherein each of the longitudinal guides further comprise a deflectable prong configured to engage the rails in a snap fit.

5. A method of securing a climate control device to a first rail and a second rail, the first rail comprising a bend that extends radially away from a longitudinal axis of the rail, the method comprising:
positioning the first rail within a longitudinal groove of a first clamp and positioning at least a portion of the bend of the rail against a longitudinal stop and a radial stop of the clamp;
positioning the first rail within a longitudinal groove of second clamp; and
positioning the second rail within a longitudinal groove of a third clamp.

6. The method of claim 5, wherein positioning the first rail within a longitudinal groove of a first clamp comprising deflecting an arm of the clamp away from the first rail.

7. The method of claim 5 further comprising inserting a fastener into the first clamp to deflect an arm of the clamp.

8. The method of claim 5, wherein positioning the first rail in the longitudinal groove of second clamp comprising deflecting a prong of the second clamp.

9. The method of claim 8, wherein positioning the second rail in the longitudinal groove of third clamp comprising deflecting a prong on the third clamp.

10. A climate control apparatus for providing air to at least a portion of a vehicle seat comprising a first rail and a second rail, the first rail comprising a bend that extends radially away from a longitudinal axis of the rail, the apparatus comprising:
a panel, the panel housing and supporting at least a portion of the climate controlled seat assembly; and
a first clamp being attached to the panel in a first location and on a first side of the panel, the first clamp configured to attach to the rail of the vehicle seat at a first rail location, the first rail location comprising at least one bend, the first clamp providing six degrees of constraint to the climate control apparatus, the first clamp comprising a first portion being flexible to allow manual installation of the climate control apparatus.

11. The climate control apparatus of claim 10, further comprising a second clamp located in a second location on the first side of the panel, the second clamp providing less degrees of constraint than the first clamp, the second clamp being attachable to the rail in a second rail location.

12. The climate control apparatus of claim 11, further comprising a third clamp located in a third location on the first side of the panel, the third clamp providing less degrees of constraint than the first clamp, the third clamp being attachable to the rail in a third rail location.

13. The climate control apparatus of claim 12, wherein the second and third rail locations are substantially straight.

14. The climate control apparatus of claim 12, wherein the second and third clamps are integrally molded with the panel.

15. The climate control apparatus of claim 8, wherein the first clamp is integrally molded with the panel.

16. A climate control apparatus for providing air to at least a portion of a vehicle seat comprising a first rail and a second rail, the first rail comprising a bend that extends radially away from a longitudinal axis of the rail, the apparatus comprising:
a panel that forms at least part of a housing for the climate control apparatus;
a first connection point comprising a longitudinal groove configured to receive the first rail;
a second connection point comprising a second longitudinal groove configured to receive the second rail; and
a clamp including means for receiving and securing the bend to prevent longitudinal and radial movement of the bend within the clamp.

17. The climate control apparatus of claim 16, wherein the clamp is integrally molded with the panel.

18. The climate control apparatus of claim 17, wherein the first and second connection points are integrally molded with the panel.

19. The climate control apparatus of claim 16, wherein first and second connection points each include a deflectable prong configured to limit radial movement of a rail within the groove.

20. The climate control apparatus of claim 16, further comprising a fastener for inserting into the clamp to secure the bend into the clamp.
